(19) United States
(12) Patent Application Publication
(10) Pub. No.: US 2005/0223334 A1
(43) Pub. Date: Oct. 6, 2005

(54) Affinity group window management system and method

(76) Inventors: Patrick R. Guido, Cary, NC (US); Paul F. McMahan, Apex, NC (US); Robert C. Leah, Cary, NC (US)

Correspondence Address: COATS & BENNETT, PLLC, P O BOX 5, RALEIGH, NC, 27602, US

(21) Appl. No.: 10/814,551

(22) Filed: Mar. 31, 2004

(51) Int. Cl. G06F 3/00

(52) U.S. Cl. 715/794; 715/781; 715/804

(57) ABSTRACT

Windows in a GUI environment may be grouped by a user into one or more affinity groups. When one of the windows in the affinity group receives window focus, all of the windows in the affinity group shift to a z-order level above windows not in the affinity group. The windows may simultaneously shift to the highest z-order level, and optionally tile, or the selected window may shift to the highest z-order level, with other windows of the affinity group in z-order levels directly below the highest level. Affinity groups may be formed by the user by dragging and dropping windows into a window group icon on a group member window or by entering window group keystroke combinations into the windows to be grouped.

### BACKGROUND

The present invention relates generally to the field of software and in particular to a system and method of affinity group window management in a GUI environment.

The use of Graphical User Interface (GUI) environments is well known in the computer arts, as evidenced by the popularity of the Microsoft Windows® and Apple Computer OS X® operating systems. In these GUI environments, applications run in separate windows, any one of which may be active at a time (also referred to as selected, or receiving the window focus). Typically, the selected or active window is raised to the top of the apparent stack of windows, or in computer graphics terms, the highest z-order level of the GUI environment.

Some applications that run in GUI environments spawn multiple, related windows, such as to provide menus of functions represented by graphical icons, or windows that provide warnings, help text, or the like. Examples include the AutoCAD® mechanical drafting application by AutoDesk, Inc., and the PhotoShop® image editing application by Adobe, Inc. A property of these multi-window applications is that when any of the windows in the application are selected, or receive the GUI environment window focus, the entire set pops to the highest z-order level, or top of the desktop, together.

This feature of multiple-window z-order level shifting when any one window receives focus is programmed into the applications. There does not currently exist a way for a user to easily select windows in a GUI environment to change z-order level together, as a group, when one of the windows is selected.

### SUMMARY

The present invention relates to a method of associating windows in a GUI environment into one or more affinity groups by a user and accessing the windows as a group. The method comprises providing a GUI environment that includes a plurality of windows, and establishing, by the user, an affinity group comprising a subset of the plurality of windows in the GUI environment such that the windows comprising the affinity group are related. The method then includes raising the z-order of windows in the affinity group above other windows in the GUI environment when any one window in the affinity group is selected.

Raising the z-order of windows in the affinity group above other windows in the GUI environment may comprise, in one embodiment, raising all windows in the affinity group to the highest z-order level. Further, it may comprise tiling the windows to simultaneously occupy the highest z-order level. In another embodiment, raising the z-order of windows in the affinity group above other windows in the GUI environment may comprise raising the selected window to the highest z-order level, and raising the other windows in the affinity group to z-order levels immediately below the highest level.

### BRIEF DESCRIPTION OF DRAWINGS

FIG. 1 is a functional block diagram of a computer system.

FIG. 2 is representative view of a GUI environment.

FIG. 3 is a flow diagram of a method of window management.

### DETAILED DESCRIPTION OF THE INVENTION

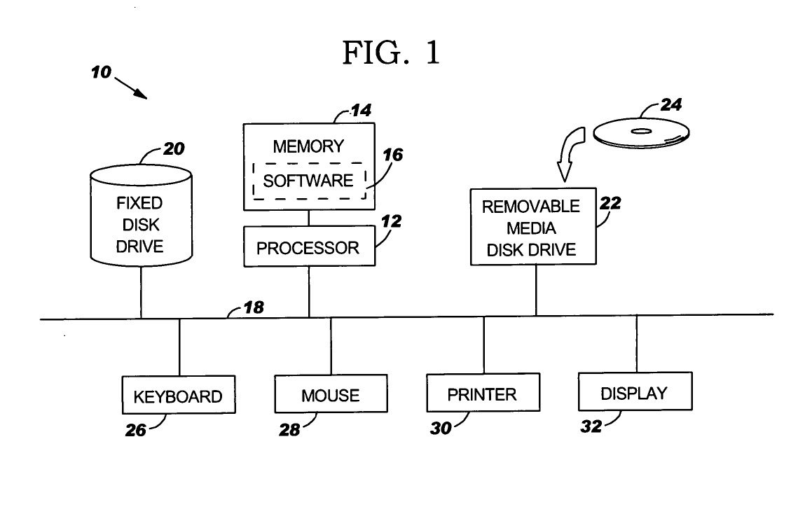

FIG. 1 depicts a functional block diagram of a representative computer system, indicated generally by the numeral 10. The computer system 10 includes a processor 12 capable of executing stored instructions. Connected to the processor 12 is memory 14 that, in operation, stores software 16. Software 16 may include an operating system and/or software running under the operating system that provides a Graphical User Interface (GUI) environment for interaction with the user.

The processor 12 is connected to a bus 18, to which are connected a variety of data storage devices and input and output devices. For example, a fixed disk drive 20 containing a computer-readable medium, from which GUI software 16 may be loaded into memory 14, may be attached to the bus 18. Additionally, a removable media disk drive 22 that receives removable computer-readable media 24 may be attached to the bus 18. The removable media 24 may comprise a floppy disk, a CD-ROM or DVD-ROM, a magnetic tape, high-capacity removable media, or the like. Removable media 24 may contain a variety of digital data, and in particular may contain GUI software 16. The software 16 may be copied from the removable media 24 to the fixed disk drive 20, and subsequently loaded into memory 14 from the fixed disk drive 20. Alternatively, the software 16 may be loaded directly from the removable media 24 into the memory 14.

Also connected to the bus 18 are input devices such as a keyboard 26 and a mouse 28, as well known in the art. The computer system 10 may additionally include output devices such as a printer 30 or display device 32. Display device 32 may comprise a traditional CRT monitor, a liquid crystal display (LCD), or the like.

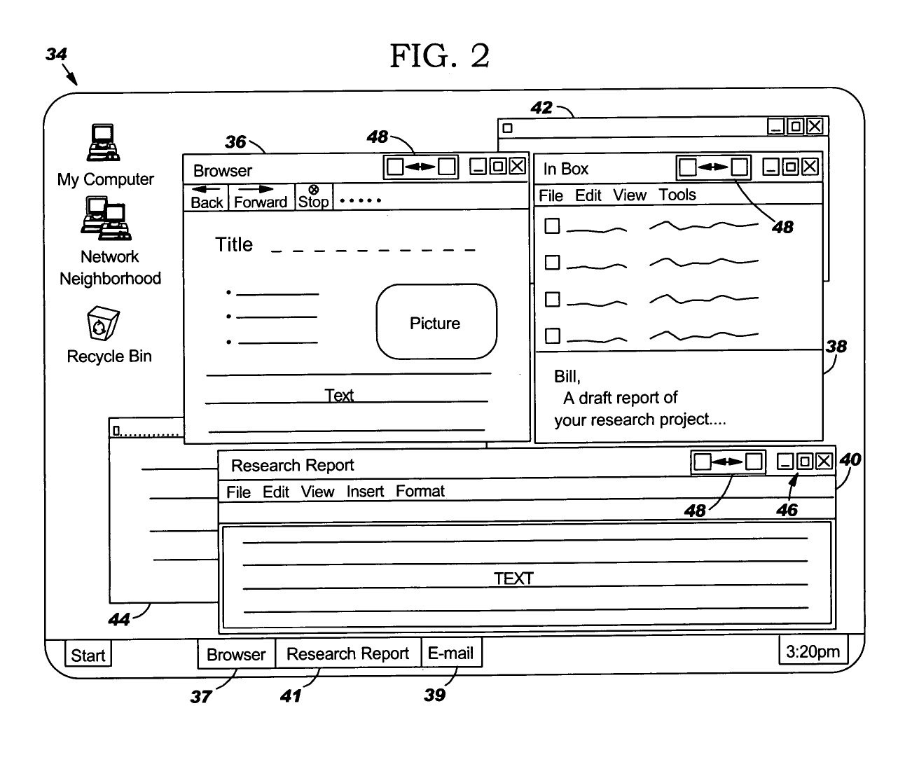

In operation, software 16 executing on the computer system 10 provides a GUI environment to the user on the display device 32, as displayed, for example, in FIG. 2, and indicated by the numeral 34. GUI-based operating systems, such as Microsoft's WINDOWS systems and Apple Computer's OS X operating system, are well known in the art. In general, the GUI environment 34 provides an interface based on the metaphor of a desktop. As is well known in the art, the GUI environment 34 may include a plurality of virtual desktops, with the contents of each virtual desktop being displayed to the user on the display device 32 in response to virtual desktop navigation inputs by the user.

A well-known advantage of a GUI environment is that it allows a user to simultaneously work with multiple, disparate applications, each running in a separate window. For example, FIG. 2 depicts the GUI environment of a user preparing a report. The user has a word processor application running in a window 40, into which he or she may type a report. For research, the user may simultaneously access the Internet via an Internet browser running in window 36. The user may also be reviewing communications with a colleague or collaborator, using an e-mail client running in window 38. In this case, the Internet browser in window 36, the e-mail client in window 38, and the word processor in window 40 are all related to the same task or operation—namely, writing a report. According to the present invention, the user may create an affinity group comprising the windows 36, 38, 40, and “pop” the group of windows the top of the GUI environment simultaneously, whenever one of the windows 36, 38, 40 is selected.

The concept of Z-ordering is well known in computer graphics, and relates to the apparent depth of graphic elements presented on a display 32. As used herein, the lowest Z-order element displayed in the GUI environment is that which appears furthest from the user, that is, on the “bottom” of the stack of overlaid windows, icons, and other GUI elements. Conversely, the highest Z-order element is that which appears on the “top” of the GUI environment. For example, a well-known behavior of GUI environments—particularly those constructed around the desktop metaphor—is that when a window is selected, or receives focus, it rises to the highest Z-order, overlying and occluding any other windows within its extent.

Under prior art GUI environment window management systems, a user could arrange the windows as depicted in FIG. 2 by independently selecting each window 36, 38, 40, “tiling” them such that neither window overlaps any portion of the other, and raising them to the highest Z-order level in the GUI environment. However, this entails independently selecting each window to raise its Z-order level, and resizing the windows to fit together on the highest Z-order level. Furthermore, if any other window, such as windows 42 or 44 in FIG. 2, is selected, and consequently raised to the highest Z-order level, each of the three windows 36, 38, 40 must be independently re-selected to return them to the highest Z-order level arrangement as depicted in FIG. 2. According to the present invention, a user may group the windows 36, 38, 40 together into an affinity group, and raise all three windows simultaneously to the highest Z-order level when any one of the windows 36, 38, 40 is selected.

The windows 36, 38, 40 may be grouped together in a variety of ways. In one embodiment, a window group icon 48 is added to each window 36, 38, 40, 42, 44 by the GUI window manager. The window group icon 48 preferably appears in the window title bar, adjacent the familiar minimize, maximize, and close buttons 46 (in the Windows desktop environment; other GUI environments typically include similar window management buttons). The window group icon 48 preferably includes a graphic suggestive of grouping windows, such as the two blocks and double-headed arrow as depicted in FIG. 2. In operation, a user may group two windows together by “dragging and dropping” a first window 36 onto the window group icon 48 of a second window 38. This is typically accomplished by moving the a cursor to the title bar of the first window 36, pressing a mouse button, moving an indicator such as an outline of the window 36 to the window group icon 48 of a second window 38, and releasing the mouse button—however, the specifics of the drag and drop operation may vary depending on the GUI environment. Upon dropping the first window 36 onto the group window icon 48 of the second window 38, the first window 36 preferably reappears in its original position, and an affinity group association is formed between the two windows 36, 38. A third window 40 may be added to the affinity group by dragging and dropping the third window 40 onto the group window icon 48 of either of the first two windows 36, 38 in the affinity group. The user thus has complete control over which windows 36, 38, 40 to group together into an affinity group, including the number of windows 36, 38, 40 in the group. A user may create multiple, independent affinity groups of windows 36, 38, 40. According to the present invention, whenever any one window 36, 38, 40 of an affinity group is selected, or receives window focus, all windows 36, 38, 40 in the affinity group simultaneously rise to the highest Z-order level in the GUI environment.

According to one embodiment of the present invention, when an affinity group of windows 36, 38, 40 is selected and rises to the highest Z-order level of the GUI environment, all of the windows 36, 38, 40 in the group are tiled, or resized and positioned so as to simultaneously display on the highest Z-order level without overlapping each other.

According to another embodiment of the present invention, when one window 36, 38, 40 of an affinity group is selected, only that window 36, 38, 40 rises to the top Z-order level, and the other windows 36, 38, 40 of the affinity group rise to Z-order levels immediately below the top level. This embodiment may be better suited to a user working with an affinity group having a large number of member windows 36, 38, 40, wherein tiling all of the windows on the highest Z-order level would leave insufficient room within each window to display an adequate portion of the corresponding application. This embodiment is also particularly applicable to an affinity group in which at least one window 36, 38, 40 requires a large display area. According to this embodiment, each window 36, 38, 40 of the affinity group may be sized to consume a large portion, or all, of the available space in the GUI environment, while maintaining the other windows 36, 38, 40 of the affinity group at the uppermost Z-order levels of the GUI environment for the user's convenience. The order of windows 36, 38, 40 within the affinity group in z-order levels below the selected window 36, 38, 40 may be the order in which they were added to the affinity group, the order in which they were created, the order in which they were last accessed, or any other ordering.

According to another embodiment of the present invention, an affinity group is established by the user by entering keystrokes, as opposed to the drag and drop operation of the GUI environment. To form an affinity group, a user may select a first window 36. With the window 36 selected, or receiving the GUI environment focus, the user inputs a window group keystroke combination. The user then selects another window 38, and enters a window group keystroke combination. This ties the two windows 36, 38 together in an affinity group. Additional windows, such as window 40, may be added to the group similarly. Preferably, the window group keystroke combination is a keystroke combination that is not recognized or acted upon by the application running in the relevant window 36, 38, 40. For example, the window group keystroke combination may include one or more qualifier keys, such as CTRL, ALT, SHIFT, or the like, and one or more “regular” keys, such as WG, representing “Window Group.” Preferably, the same window group keystroke combination is used to select each of the windows 36, 38, 40 to be added to the affinity group. Alternatively, a first window group keystroke combination may be utilized upon selecting the first window 36 such as for example, CTRL-PageUp, to mimic the “pick up” phase of the drag and drop operation. A second window group keystroke combination may then be used upon selecting the second window 38, such as CTRL-PageDown. The use of separate window group keystroke combinations more closely mimics the “drag and drop” operation using the GUI environment.

As with the drag and drop operation, a user may create multiple, separate affinity groups using the window group keystroke combination. Assuming a first affinity group has been established comprising windows 36, 38, 40, a user may create a second affinity group by selecting, for example, window 42, executing a window group keystroke combination, selecting another window that is not a member of the first affinity group, such as window 44, and entering a window group keystroke combination. This will tie windows 42, 44 into a second affinity group. According to the present invention, there is no limit to the number of affinity groups that a user may create. In particular, in a virtual desktop in GUI environment, where a large number of windows may be created and maintained, affinity groups are useful for managing windows 36, 38, 40 running related applications, and the affinity group relationship is retained across the virtual desktop spaces.

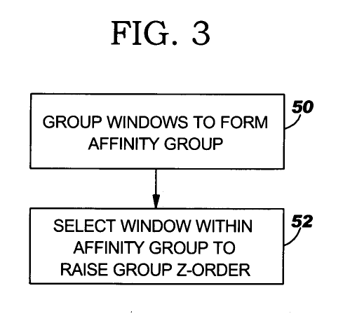

FIG. 3 depicts a flow diagram representation of the window management method according to the present invention. A user first groups the desired windows 36, 38, 40 together to form an affinity group, at step 50. This may, for example, comprise dragging and dropping one such window 36, 38, 40 onto the window group icon 48 of another window 36, 38, 40 in the group. Alternatively, this may comprise selecting one window 36, 38, 40, executing a window group keystroke combination, selecting a second window 36, 38, 40 in the group, and executing another window group keystroke combination.

At step 52, the user selects any window 36, 38, 40, within the affinity group, to raise the Z-order level of the entire group. This operation depends on the GUI environment, but typically comprises placing the cursor on some exposed portion of the window for a predetermined duration or alternately clicking a mouse button; selecting an associated window icon 37, 39, 41; cycling window focus through all open windows (such as by the ALT-TAB keystroke in the Windows GUI environment) or the like. Selecting one window 36, 38, 40 may raise all of the windows 36, 38, 40 in the group to the highest Z-order level in the GUI environment simultaneously, as depicted in FIG. 2. Alternatively, this may raise only the selected window 36, 38, 40 to the highest Z-order level, and raise the other windows 36, 38, 40 of the affinity group to Z-order levels immediately below the highest level.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of associating windows in a GUI environment into one or more affinity groups by a user and accessing the windows as a group, comprising:
providing a GUI environment including a plurality of windows;
establishing, by a user, a first affinity group comprising a subset of two or more but less than all of said plurality of windows in said GUI environment, such that the windows comprising said first affinity group are related; and
raising the z-order of windows in said first affinity group above other windows in said GUI environment when any one window in said first affinity group is selected.

2. The method of claim 1 wherein raising the z-order of windows in said first affinity group above other windows in said GUI environment when any one window in said first affinity group is selected comprises raising all windows in said first affinity group to the top level z-order of said GUI environment.

3. The method of claim 2 further comprising tiling the windows in said first affinity group such that said windows may simultaneously occupy the top level z-order of said GUI environment.

4. The method of claim 1 wherein raising the z-order of windows in said first affinity group above other windows in said GUI environment when any one window in said first affinity group is selected comprises raising the selected window to the top level z-order of said GUI environment, and raising all other windows in said first affinity group to one or more z-order levels immediately below the top level.

5. The method of claim 1 wherein establishing said first affinity group of windows comprises designating an affinity relationship between existing windows in said GUI by the user.

6. The method of claim 5 wherein designating an affinity relationship between existing windows by the user comprises:
selecting a first window;
dragging said first window to an affinity group icon on a second window; and
dropping said first window on said affinity group icon of said second window, thereby establishing an affinity group relationship between said first and second window.

7. The method of claim 6, further comprising:
selecting a third window;
dragging said third window to an affinity group icon on either said first or second window; and
dropping said third window on said affinity group icon of said first or second window, thereby adding said third window to said affinity group.

8. The method of claim 5 wherein designating an affinity relationship between existing windows by the user comprises:
selecting a first window;
executing a first keystroke combination in said first window;
selecting a second window; and
executing a second keystroke combination in said second window, thereby establishing an affinity group relationship between said first and second window.

9. The method of claim 8, further comprising:
selecting a third window;
executing said first keystroke combination in said third window;
selecting either said first or second window; and
executing said second keystroke combination in said selected first or second window, thereby adding said third window to said affinity group.

10. The method of claim 1 wherein establishing said first affinity group of windows comprises creating one or more new windows from an existing window by the user, said existing window and said new windows having an affinity group relationship.

11. The method of claim 10, wherein creating one or more new windows from an existing window by the user comprises:
selecting an existing window; and
creating a first new window by executing an affinity group window creation command;
whereby said first new window created has an affinity group relationship with said existing window.

12. The method of claim 11, further comprising:
selecting either said existing window or said first new window; and
creating a second new window by executing an affinity group window creation command;
whereby said second new window created has an affinity group relationship with said existing window and said first new window.

13. The method of claim 1 wherein said GUI environment includes virtual desktops.

14. A method of switching between two or more groups of windows in a GUI environment, comprising:
providing a GUI environment including a plurality of windows, said windows divided into at least first and second affinity groups, each said affinity group comprising two or more but less than all of said plurality of windows;
raising the windows of said first affinity group to a z-order level above the windows of said second affinity group in said GUI environment in response to the user selecting a window in said first affinity group; and
raising the windows of the second affinity group to a z-order level above the windows of said first affinity group in said GUI environment in response to the user selecting a window in said second affinity group.

15. The method of claim 14 wherein said second affinity group comprises all windows in said GUI environment not otherwise included in an affinity group.

16. The method of claim 14 wherein raising the z-order of windows in said first affinity group comprises raising all windows in said first affinity group to the top level z-order of said GUI environment.

17. The method of claim 16 further comprising tiling the windows in said first affinity group such that said windows may simultaneously occupy the top level z-order of said GUI environment.

18. The method of claim 14 wherein raising the z-order of windows in said first affinity group comprises raising the selected window to the top level z-order of said GUI environment, and raising all other windows in said first affinity group to one or more z-order levels immediately below the top level.

19. A computer system, comprising:
a display device;
at least one input device; and
a processor programmed to display a GUI environment including a plurality of windows and a plurality of z-order levels on said display device, said GUI environment operative to allow a user to form affinity groups of said windows via said input device and to select one said window to receive a GUI environment window focus, such that when a window in an affinity group receives said window focus, all windows within said affinity group rise to one or more z-order levels higher than all windows not within said affinity group.

20. The computer system of claim 19 wherein when a window in an affinity group receives said window focus, all windows within said affinity group rise to the highest z-order level of said GUI environment.

21. The computer system of claim 20 wherein all windows within said affinity group are tiled to fit within the highest z-order level of said GUI environment.

22. The computer system of claim 19 wherein when a window in an affinity group receives said window focus, the window receiving said focus rises to the highest z-order level of said GUI environment, and all other windows within said affinity group rise to z-order levels directly below said highest level.

23. The computer system of claim 19 wherein said at least one input device includes a mouse, and wherein said GUI environment is operative to allow a user to form affinity groups of said windows by dragging a first said window and dropping in on a window group icon on a second said window, thereby forming an affinity group relationship between said first and second windows.

24. The computer system of claim 19 wherein said at least one input device includes a keyboard, and wherein said GUI environment is operative to allow a user to form affinity groups of said windows by successively entering one or more window group keystroke combinations into first and second said windows, thereby forming an affinity group relationship between said first and second windows.

25. A computer readable medium which stores computer-executable process steps for a GUI environment including a plurality of windows and a plurality of z-order levels, said computer-executable process steps causing a computer to perform the steps of:
displaying said GUI environment on a display device;
accepting, from a user, designation of a first affinity group comprising a subset of two or more but less than all of said plurality of windows in said GUI environment, such that the windows comprising said first affinity group are related; and
raising the z-order of windows in said first affinity group above other windows in said GUI environment when any one window in said first affinity group is selected.

26. The computer readable medium of claim 25 wherein raising the z-order of windows in said first affinity group above other windows in said GUI environment when any one window in said first affinity group is selected comprises raising all windows in said first affinity group to the top level z-order of said GUI environment.

27. The computer readable medium of claim 26 further comprising tiling the windows in said first affinity group such that said windows may simultaneously occupy the top level z-order of said GUI environment.

28. The computer readable medium of claim 25 wherein raising the z-order of windows in said first affinity group above other windows in said GUI environment when any one window in said first affinity group is selected comprises raising the selected window to the top level z-order of said GUI environment, and raising all other windows in said first affinity group to one or more z-order levels immediately below the top level.
